(19) United States
(12) Patent Application Publication
(10) Pub. No.: US 2024/0029087 A1
(43) Pub. Date: Jan. 25, 2024

(54) System and Method for Assessing a User's Likelihood of an In-Store Visit Based on the User's Social Media Activity

(71) Applicant: Patrick Greer-Moroney, Beacon, NY (US)

(72) Inventor: Patrick Greer-Moroney, Beacon, NY (US)

(21) Appl. No.: 18/477,922

(22) Filed: Sep. 29, 2023

Related U.S. Application Data
(63) Continuation-in-part of application No. 17/963,890, filed on Oct. 11, 2022.
(60) Provisional application No. 63/254,481, filed on Oct. 11, 2021.

(51) Int. Cl. G06Q 30/0201; G06Q 50/00; G06Q 30/0241

(52) U.S. Cl. CPC G06Q 30/0201; G06Q 50/01; G06Q 30/0277

(57) ABSTRACT

A system and a method for assessing a user's likelihood of an in-store visit based on the user's social media activity enables businesses to track metrics from a social media network to target users who are more likely to promote word-of-mouth engagement and drive in-store sales. A virtual presence for a physical store on a social media network is managed. Virtual interactions between each user account and the virtual presence are tracked. Further, engaged accounts from the user accounts of the social media platform are designated. Physical interactions between each engaged account and the physical store are tracked. Further, a clout-and-loyalty-based rating process is executed by inputting the number of virtual interactions and the number of physical interactions for each engaged account into the clout-and-loyalty-based rating process. Furthermore, the clout-and-loyalty-based rating process is executed by outputting a clout-and-loyalty rating for each engaged account with the clout-and-loyalty-based rating process.

The current application is a continuation-in-part (CIP) application of a U.S. non-provisional application Ser. No. 17/963,890 filed on Oct. 11, 2022. The U.S. non-provisional application Ser. No. 17/963,890 claims a priority to a U.S. provisional application Ser. No. 63/254,481 filed on Oct. 11, 2021.

### FIELD OF THE INVENTION

The present invention relates generally to data processing and customer engagement. More specifically, the present invention provides means for facilitating relationship building between a business and consumers.

### BACKGROUND OF THE INVENTION

The importance of data processing has increased in several industries, business organizations, and/or individuals. Nowadays, most business processes require a level of data processing to achieve the business goals more efficiently. For example, data processing is extremely valuable when studying customer patterns to understand how a product may be better marketed to customers. Data processing has also been largely applied to costumer engagement. In general, customer engagement refers to the methods a business utilizes to foster brand loyalty and awareness. Traditionally, word of mouth is the standard for all successful business relationships. However, due to various obstacles such as the latest global pandemic, many businesses have now been put in a place where in-person traffic has mitigated their ability to reach customers to create the bonds that facilitate a strong word of mouth relationship.

Existing techniques for facilitating customer engagement are deficient regarding several aspects relating to in-person consumer and local business relationships. For instance, current technologies (such as social media and web-based channels) facilitate building relationships but lack the ability for businesses to focus marketing efforts to entice a consumer to come in person. When individuals post/tag/take a photo at a business' physical location, current technologies do not track relevant metrics that can be utilized to entice customers to bring others to the physical location. Further, current technologies do not facilitate brokering the relationship that allows businesses to establish incentives utilizing their most marketable asset (e.g., Pay for Posting). Further, while current technologies create a pathway for businesses to interact with customers and vice versa, current technologies do not facilitate interlinked tracking that allows the business to establish a stronger digital ‘word of mouth’ relationship with a user. Furthermore, current technologies do not allow a business to track potential advertising opportunities from the user's social media posts. Therefore, there is a need for improved means for assessing a user's likelihood of an in-store visit based on the user's social media activity that may overcome one or more of the above-mentioned problems and/or limitations.

### SUMMARY OF THE INVENTION

A system and a method for assessing a user's likelihood of an in-store visit based on the user's social media activity are disclosed. The present invention creates a link between businesses and consumers to foster customer engagement through online activities. The present invention enables the use of various metrics from existing analytics extracted from the social media platform to promote word of mouth transactions. The method of the present invention can track specific and related metrics including, but not limited to, post views, likes, shares, etc. In addition, impressions and other exposure-based qualities can be tracked. Further, these metrics are processed and extrapolated by the system of the present invention so that the results can be used to promote word of mouth relationships with specific users. As a result, vendor-specific incentives can be generated to reward the users who greatly increase word of mouth virtual engagement.

### BRIEF DESCRIPTION OF THE DRAWINGS

FIG. 1 is a schematic diagram showing the overall system of the present invention.

FIG. 2 is a flowchart showing the overall method of the present invention.

FIG. 3 is a flowchart showing the continuation of the overall method of the present invention.

FIG. 4 is a flowchart showing the subprocess of facilitating the business's marketing on the social media network.

FIG. 5 is a flowchart showing the subprocess of accurately tracking the virtual engagement of users with the marketing efforts on social media networks.

FIG. 6 is a flowchart showing the subprocess of tracking the user's social media activity related to the physical store.

FIG. 7 is a flowchart showing the subprocess of monitoring the social media network for negative commentary.

FIG. 8 is a flowchart showing the subprocess of maintaining the database of negative comments updated.

FIG. 9 is a flowchart showing the subprocess of tracking user engagement with a user's social media posts.

FIG. 10 is a flowchart showing the subprocess of validating a physical interaction using a geofenced area of the physical store.

FIG. 11 is a flowchart showing the subprocess of validating a financial transaction made by the user at a physical store.

FIG. 12 is a flowchart showing the subprocess of performing the clout-and-loyalty-based rating process utilizing the user's virtual scores and benchmarks and the user's physical scores and benchmarks.

### DETAILED DESCRIPTION OF THE INVENTION

All illustrations of the drawings are for the purpose of describing selected versions of the present invention and are not intended to limit the scope of the present invention.

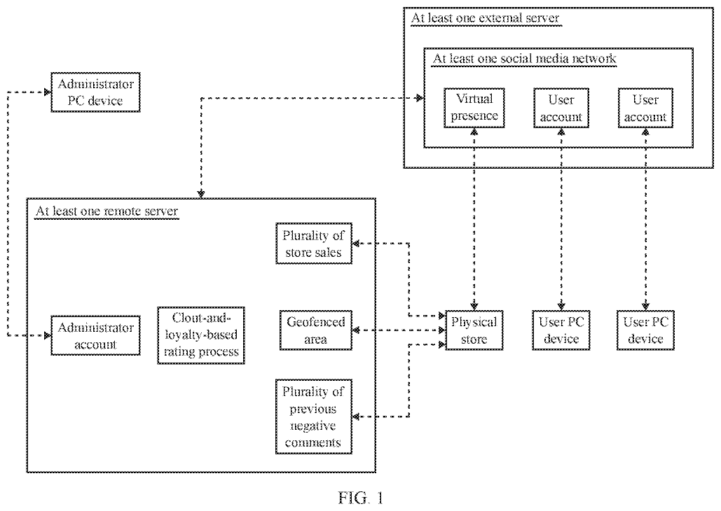

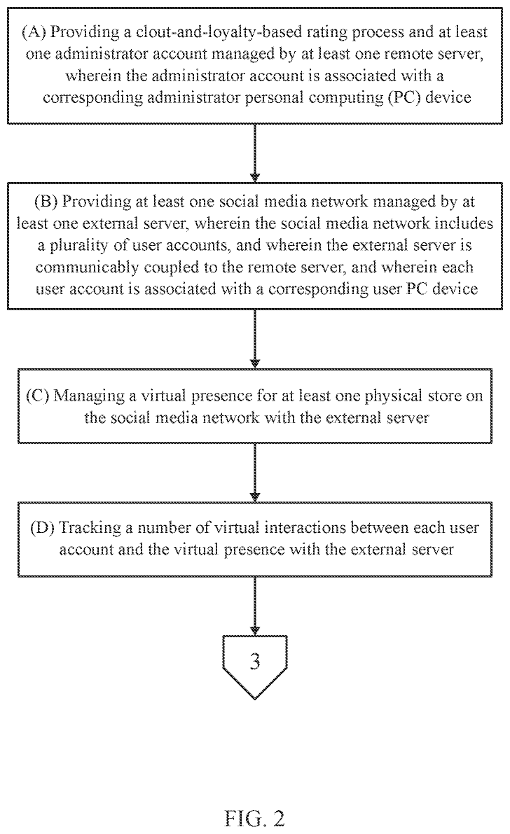

The present invention provides a system and a method for assessing a user's likelihood of an in-store visit based on the user's social media activity. The present invention enables businesses to track metrics obtained from the analytics of a social media network to target specific users who are more likely to promote word-of-mouth engagement and drive in-store sales. To do so, the present invention includes a system that enables the recording and processing of metrics obtained from the social media platform's analytics. As can be seen in FIGS. 1 and 2, the system of the present invention may include a clout-and-loyalty-based rating process and at least one administrator account managed by at least one remote server (Step A). The clout-and-loyalty-based rating process is designed to enable the automatic rating of social media users based on various metrics including, but not limited to, social media activity, user engagement, brand loyalty, etc. The administrator account corresponds to any authorized account with the correct permissions to access the collected data to configure the clout-and-loyalty based rating process. Further, the administrator account is associated with a corresponding administrator personal computing (PC) device. The corresponding administrator PC device can include, but is not limited to, any computing device with Internet access such as a smartphone, laptop, desktop computer, etc.

As can be seen in FIGS. 1 and 2, the system of the present invention may further include at least one social media network managed by at least one external server (Step B). The social media network can be any platform that can be accessed via commonly used communication protocols including, but not limited to, the platform's Application Programming Interface (API). In addition, the social media network includes a plurality of user accounts corresponding to the several users who are registered with the social media network. Furthermore, the external server is communicably coupled to the remote server through the different communication protocols, and each user account is associated with a corresponding user PC device. Like the corresponding administrator PC device, the corresponding user PC device can be any computing device capable of connecting to the Internet to have access to the social media network.

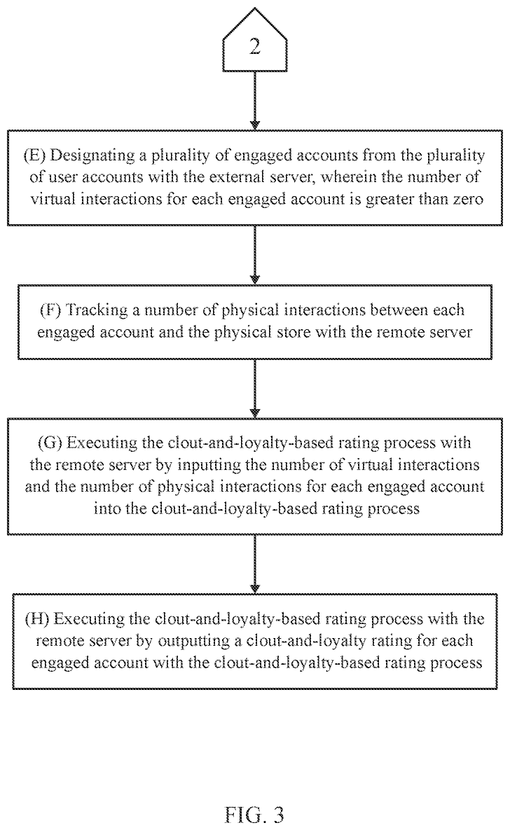

An overall process for the method of the present invention enables the processing of metrics obtained from the social media network's analytics to determine the likelihood of users to promote word-of-mouth engagement with other users as well as to determine the likelihood of performing in-store purchases. As can be seen in FIGS. 2 and 3, the overall method for assessing a user's likelihood of an in-store visit based on the user's social media activity includes the steps of managing a virtual presence for at least one physical store on the social media network with the external server (Step C). The virtual presence for the physical store can include, but is not limited to, social media posts, engagement with user's social media posts, marketing, and advertising on social media networks, etc. Further, a number of virtual interactions is tracked between each user account and the virtual presence with the external server (Step D). A virtual interaction is when a user of a social media network is able to interact with a virtual presence on the physical store through the social media network, such as liking the physical store's posts or sharing the physical store's posts. Each virtual interaction is recorded and counted by the external server. Further, a plurality of engaged accounts from the plurality of user accounts is designated with the external server (Step E). An engaged account is preferably a user account with a number of virtual interactions that is greater than zero. In other words, any user account that interacts with the virtual presence of the physical store is designated as an engaged account.

As can be seen in FIGS. 2 and 3, a number of physical interactions between each engaged account and the physical store is also tracked with the remote server (Step F). Like the virtual interactions, physical interactions between users and the physical store are tracked to determine the level of physical engagement. For example, a physical interaction can be, but is not limited to, a physical purchase made from the physical store, a physical visit to the store, etc. by a user of the social media network. Further, the clout-and-loyalty-based rating process is executed with the remote server by inputting the number of virtual interactions and the number of physical interactions for each engaged account into the clout-and-loyalty-based rating process (Step G). This way, both the virtual interactions and the physical interactions are taken into account when evaluating the engaged accounts. Furthermore, the clout-and-loyalty-based rating process is executed with the remote server by outputting a clout-and-loyalty rating for each engaged account with the clout-and-loyalty-based rating process (Step H). For example, the clout-and-loyalty rating can be a numerical rating on a scale that can be used to determine the likely hood of a social media user to engage with the physical store in person and online. As a result, the present invention is able to quantitatively compare the engaged users' loyalty to the physical store among each other.

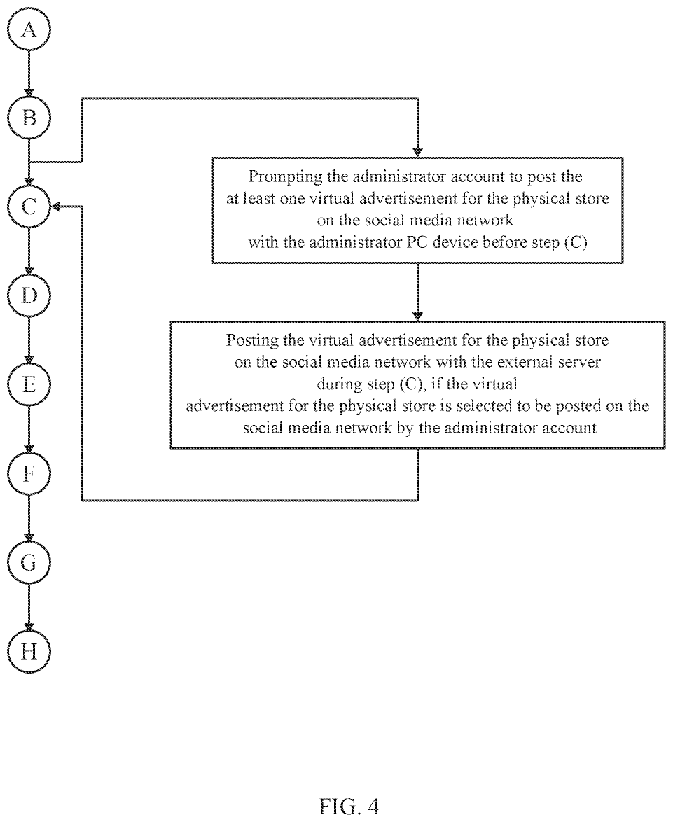

As previously discussed, the present invention can track different virtual interactions made in the social media network. This enables the identification of users who are likely to make social media posts. The system of the present invention would analyze user data, including social media activity and purchase history, to identify users who are likely to make social media posts about the business or organization. In one embodiment, some of the virtual interactions include marketing efforts made on the social media network by the business or organization to engage the users of the social media network. The system of the present invention is designed to track the virtual interactions that the users perform with the marketing efforts of the business or organization on the social media network. To do so, the system of the present invention enables the business or organization to post targeted marketing on the social media network. As can be seen in FIG. 4, the subprocess of facilitating the business's marketing on the social media network begins by prompting the administrator account to post at least one virtual advertisement for the physical store on the social media network with the administrator PC device before Step C. Through the administrator account, the business or organization can post advertisements in the form of social media posts or through other marketing methods implemented by the social media network. The virtual advertisement for the physical store is then posted on the social media network with the external server during Step C, if the virtual advertisement for the physical store is selected to be posted on the social media network by the administrator account. This way, the business or organization can utilize targeted marketing to determine the most influential users of the social media network that promote word-of-mouth engagement and that drive in-person sales.

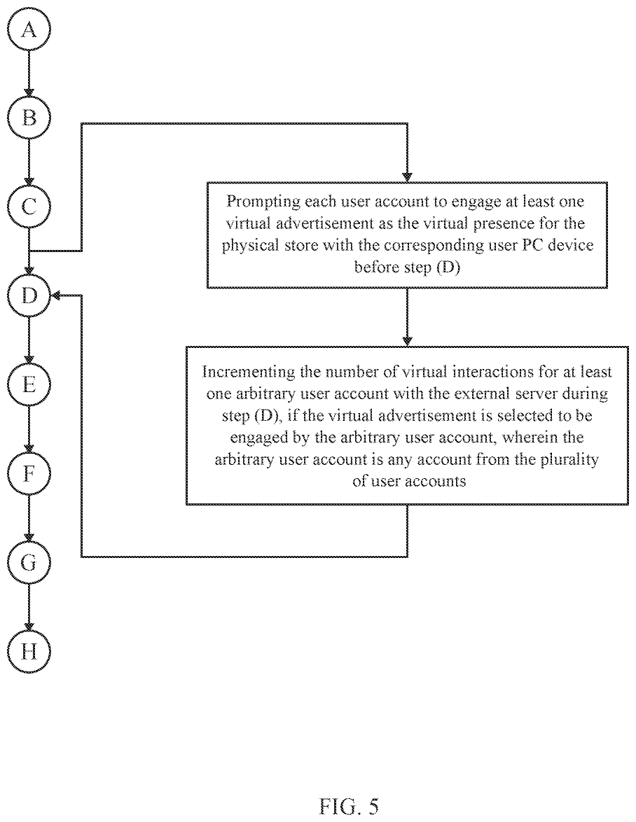

Further, the system of the present invention is designed to accurately track the level of virtual engagement of the social media network user with the marketing efforts on the social media network by the business or organization. This can help identify customer preferences and behavior to obtain insights into the preferences and behavior of users who are likely to take photos and make social media posts. Some of the behavior tracked can include, but is not limited to, types of products or services the users are interested in, the times of day when the users are most likely to visit a business, and the social media networks the users are most active on. As can be seen in FIG. 5, the subprocess of accurately tracking the virtual engagement of users with the marketing efforts on social media networks begins by prompting each user account to engage at least one virtual advertisement as the virtual presence for the physical store with the corresponding user PC device before Step D. The virtual advertisement can include social media posts that include marketing material about the physical store. In other words, each user of the social media network has the option to engage with the advertising posted on the social media network by the business or organization. Further, the number of virtual interactions for at least one arbitrary user account is incremented with the external server during Step D, if the virtual advertisement is selected to be engaged by the arbitrary user account. The arbitrary user account is preferably any account from the plurality of user accounts of the social media network. This way, the user accounts that engage with the marketing of the business or organization on the social media network are quantitatively tracked by the system of the present invention to determine the most influential users who can spread word-of-mouth engagement.

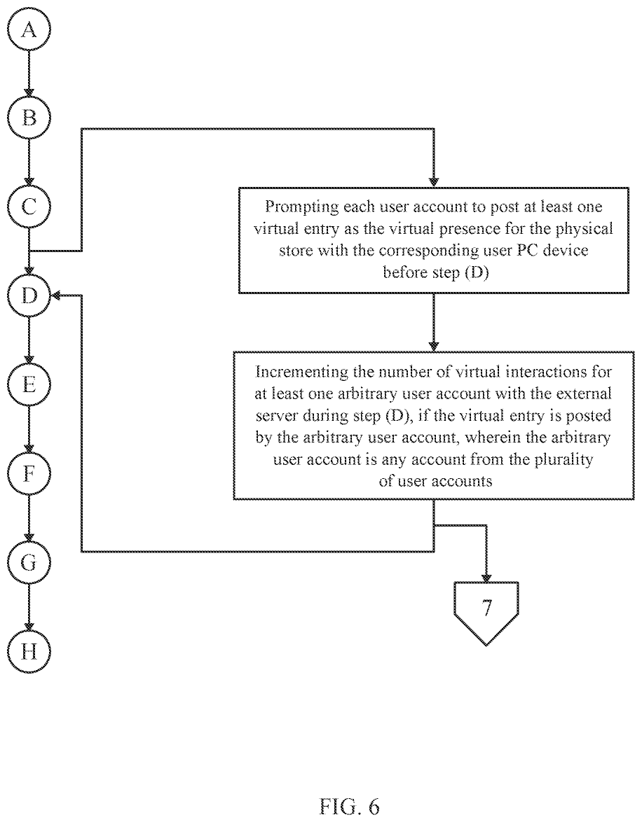

As previously discussed, the system of the present invention is also designed to keep track of the virtual interactions from the user's social media activity related to the business or organization. In one embodiment, the system of the present invention can be designed to track the user's social media posts on the social media network related to the business or organization. As can be seen in FIG. 6, the subprocess of tracking the user's social media activity related to the physical store begins by prompting each user account to post at least one virtual entry as the virtual presence for the physical store with the corresponding user PC device before Step D. In other words, each user can make individual posts on the corresponding social media accounts, and the system of the present invention keeps track of the individual posts that may include content related to the physical store. Further, the number of virtual interactions for at least one arbitrary user account is incremented with the external server during Step D, if the virtual entry is posted by the arbitrary user account. This way, the user's individual posts can increase the virtual engagement of the users if any of the user's individual posts include content regarding the physical store of the business or organization.

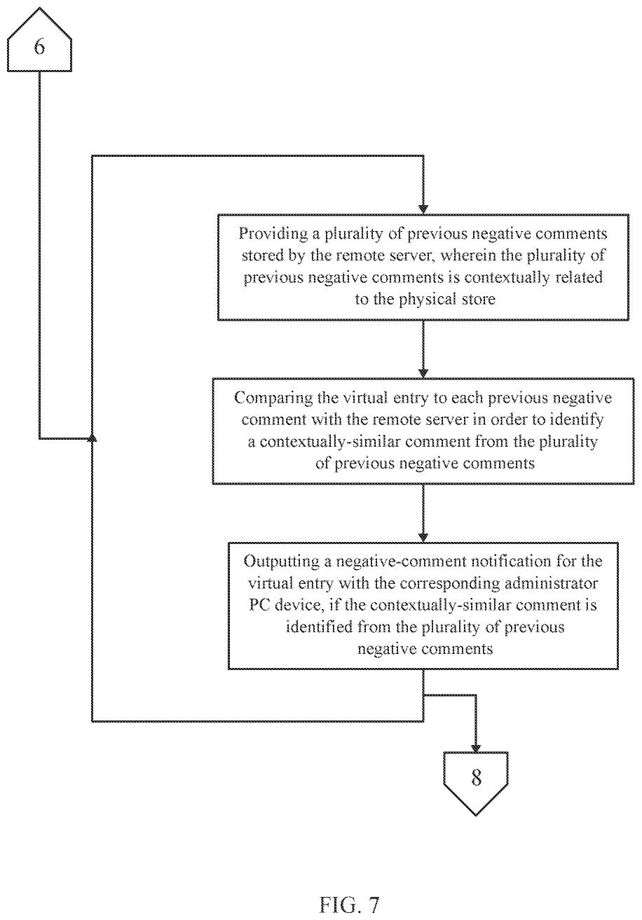

In addition to tracking the user's individual posts to monitor the user's virtual engagement with the business or organization, the present invention can further include means for reputation management to enable businesses or organizations to maintain a good presence on the social media network. The system of the present invention can be set to monitor the online presence of the business, identify negative comments or feedback, and take action to address the issues before the issues become a problem for the business or organization. As can be seen in FIGS. 1 and 7, the system of the present invention may further include a plurality of previous negative comments stored by the remote server. The negative comments include negative content that may portray the business or organization in a negative image. The plurality of previous negative comments is contextually related to the physical store to facilitate the tracking of relevant comments that may negatively portray the business or organization. The subprocess of monitoring the social media network for negative commentary begins by comparing the virtual entry to each previous negative comment with the remote server in order to identify a contextually-similar comment from the plurality of previous negative comments. This way, the user's individual posts can be monitored for any comment that negatively portrays the business or organization based on the previously-made negative commentary. Further, a negative-comment notification for the virtual entry is output with the corresponding administrator PC device, if the contextually-similar comment is identified from the plurality of previous negative comments. This enables the administration of the business or organization to take the necessary actions to remedy the situation, if necessary. For example, the administrator account can contact the corresponding user account to resolve any issues the user may have with the physical store. Thus, the business or organization can maintain a good reputation on the social media network to increase the word-of-mouth engagement.

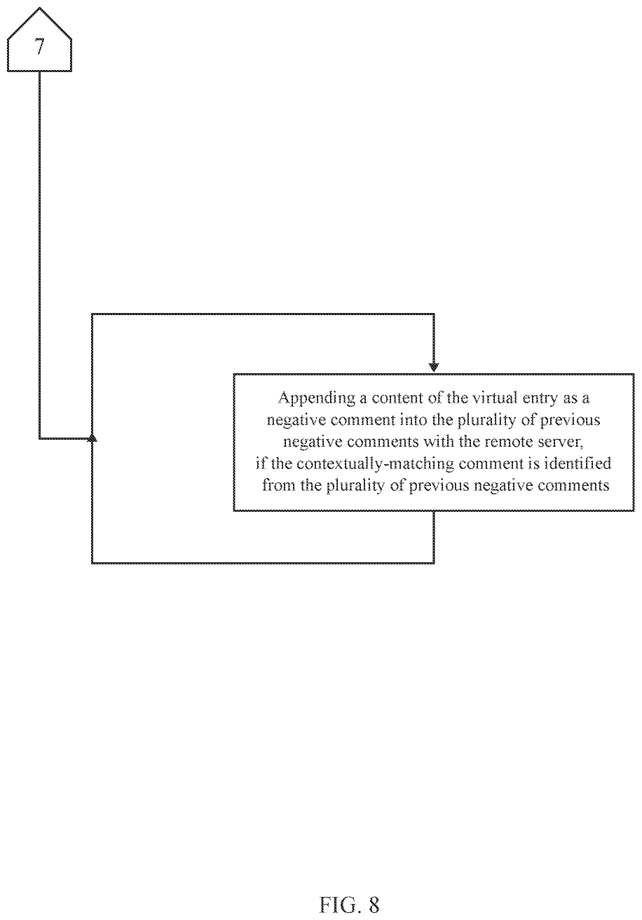

Further, the database of previous negative comments can be constantly updated to ensure that most possible variations of negative commentary are detected by the system of the present invention. As can be seen in FIG. 8, the subprocess of maintaining an updated database of previous negative comments proceeds by appending a content of the virtual entry as a negative comment into the plurality of previous negative comments with the remote server, if the contextually-matching comment is identified from the plurality of previous negative comments. In other words, the database of previous negative comments is automatically updated by constantly identifying possible variations of negative comments and appending the new variations to the database. Alternatively, the administration may update the database of previous negative comments by manually inputting new variations of negative comments that may affect the image of the business or organization in the social media network.

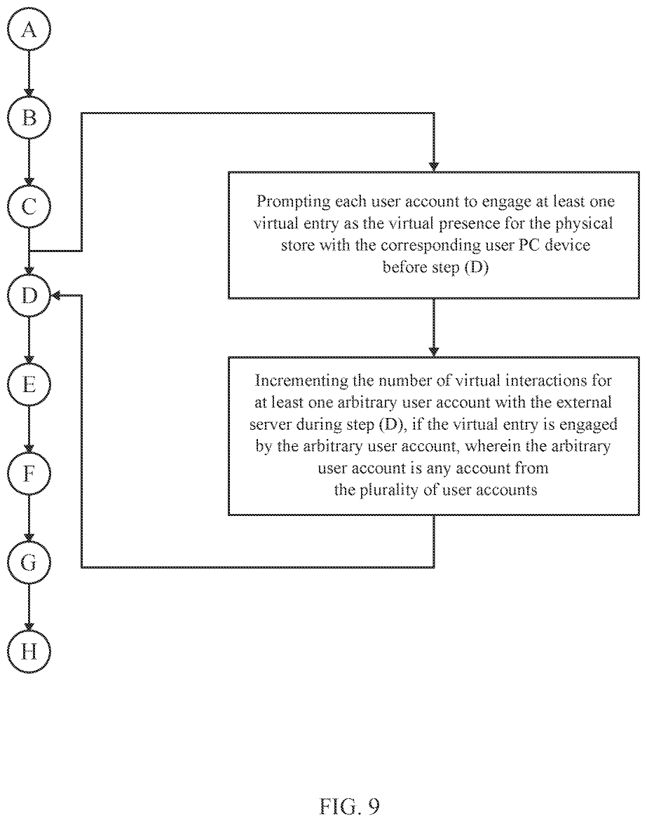

In order to track and reward users who have a greater word-of-mouth influence, the system of the present invention measures the influence of social media users that is relevant to the business or organization. For example, social media users whose social media posts achieve greater engagement from other users can be rated higher using the method of the present invention. As can be seen in FIG. 9, the subprocess of tracking user engagement with a user's social media posts begins by prompting each user account to engage at least one virtual entry as the virtual presence for the physical store with the corresponding user PC device before Step D. In other words, users of the social media network can choose to engage with a user's social media post that is relevant to the business or organization. Then, the number of virtual interactions for at least one arbitrary user account is incremented with the external server during Step D, if the virtual entry is engaged by the arbitrary user account. In some embodiments, different rating weights can be applied to the user according to the level of engagement the user's social media post achieves.

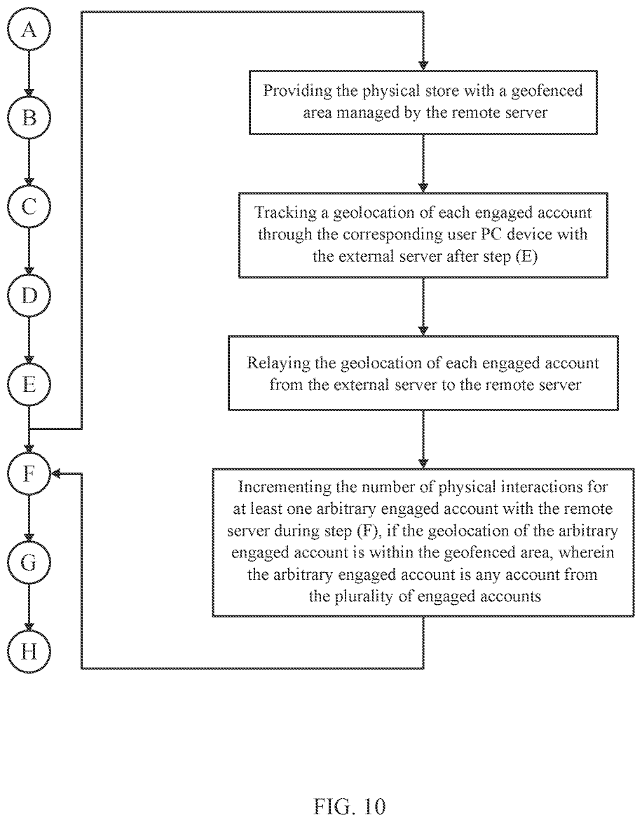

As previously discussed, the system of the present invention is also able to keep track of the physical interactions between the user and the physical store of the business or organization. As can be seen in FIGS. 1 and 10, the system of the present invention can utilize various methods to effectively confirm that the user has performed certain physical interactions at the physical store of the business or organization. In one embodiment, the present invention can utilize location services of the corresponding user PC device to authenticate the physical interactions between the user and the physical store of the business or organization. To do so, the system of the present invention may provide the physical store with a geofenced area managed by the remote server. The geofenced area preferably corresponds to a virtual area matching the overall physical location of the physical store of the business or organization. The geofenced area helps the system of the present invention to accurately determine the physical interaction of the user with the physical store of the business or organization. In addition, as can be seen in FIG. 10, the subprocess of validating a physical interaction using a geofenced area of the physical store begins by tracking a geolocation of each engaged account through the corresponding user PC device with the external server after Step E. The location services of the corresponding user PC device are preferably used. However, other geolocation services that can be used with the corresponding user PC device can be utilized by the present invention. The geolocation of each engaged account is then relayed from the external server to the remote server so that the remote server can automatically track the potential physical interactions between the user and the physical store of the business or organization. Next, the number of physical interactions for at least one arbitrary engaged account is incremented with the remote server during Step F, if the geolocation of the arbitrary engaged account is within the geofenced area. In other words, if the geolocation data obtained from the corresponding user PC device is determined to be within the geofenced area of the physical store, the remote server can consider that the user has performed a physical interaction with the physical store. For example, the geofenced area can be designed to match the interior of the physical store so that user must have entered the physical store in order to determine that the user has performed a physical interaction. Alternatively, the geofenced area can be expanded to the surroundings of the physical store to also consider visits of the user to the physical store where the user does not enter the physical store.

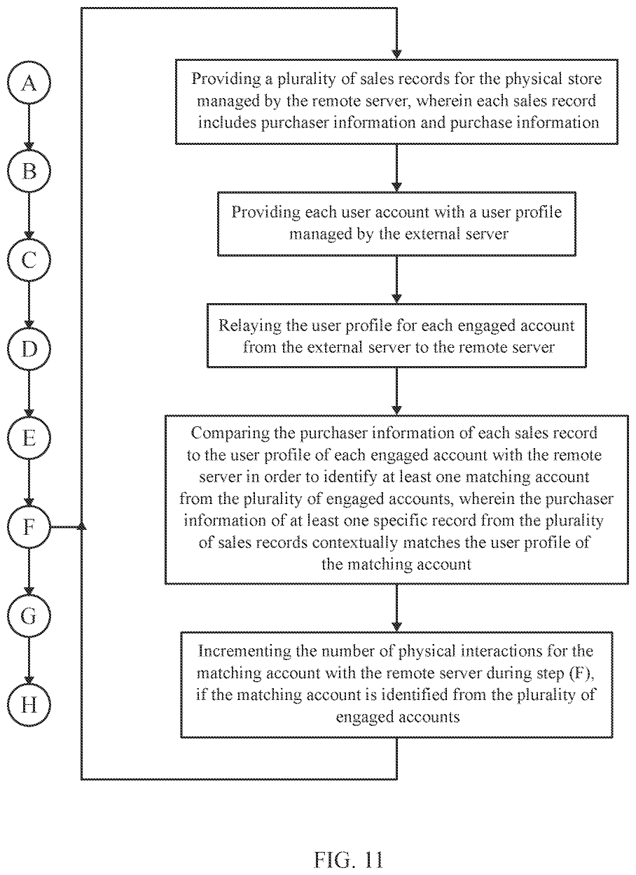

While the geofenced area provides accurate data of the user's physical interaction with the physical store of the business or organization, the present invention can provide further means to more accurately determine the type of physical interaction performed by the user. In some embodiments, the present invention can further provide means to determine if the user performed a financial transaction at the physical store of the business or organization. As can be seen in FIGS. 1 and 11, the system of the present invention may further include a plurality of sales records for the physical store managed by the remote server. The plurality of sales records includes digitized information about the sales made at the physical store. Each sales record includes purchaser information and purchase information that can be used to determine the identity of the user who performed the financial transaction at the physical store. The purchaser information can include, but is not limited to, the name of the person making the purchase as well as payment information. The purchase information can include, but is not limited to, the description of items or services purchased as well as the physical store information where the purchase was made. Moreover, as can be seen in FIG. 11, the system of the present invention may also provide each user account with a user profile managed by the external server. The user profile can be automatically generated based on collected data from the user's virtual interactions and physical interactions. Alternatively, the user profile can be manually created by each user when the user registers with the services of the present invention. For example, a software application can be provided that enables the user to register with the present invention by creating a user profile.

In addition, as can be seen in FIG. 11, the subprocess of validating a financial transaction made by the user at a physical store begins by relaying the user profile for each engaged account from the external server to the remote server to provide access to the remote server to data as part of the user profile. The purchaser information of each sales record is then compared to the user profile of each engaged account with the remote server in order to identify at least one matching account from the plurality of engaged accounts. To identify a matching account from the plurality of engaged accounts, the purchaser information of at least one specific record from the plurality of sales records must contextually match the user profile of the matching account. In other words, the purchaser information is compared to the user profile to determine if the user performed the financial transaction. For example, if the user performed the financial transaction using a credit card, the credit card information can be matched to the user profile to validate the physical interaction. The number of physical interactions for the matching account is finally incremented with the remote server during Step F, if the matching account is identified from the plurality of engaged accounts. Thus, the user's clout-and-loyalty rating improves when financial transactions made at the physical store are validated by the present invention. In other embodiments, the user can manually verify the physical interaction with the corresponding user PC device. For example, the user can utilize the corresponding software application of the present invention to scan the physical proof of the physical interaction, such as a receipt that the system can use to validate the physical interaction. Further, physical codes, such as matrix barcodes, can be provided on the physical store of the business or organization which the user can scan with the corresponding user PC device to validate the physical interaction the user has performed at the physical store.

As previously discussed, the present invention can provide a software platform that links registered users and the businesses or organizations on the platform. The user, business, and/or organization can register on the software platform via a software application such as a mobile application to access the features and services of the present invention. Accordingly, the software platform can provide for users the means to register and log into the software platform utilizing the user's social media credentials. A unique interface can be provided to the user, business, and/or organization depending on the features that each user is authorized access to. Accordingly, once the user, business, and/or organization registers, the system of the present invention may record and transmit the relevant data to the remote server to be utilized for each user account. Metrics associated with the user data may validate and qualify the virtual interactions and the physical interactions. Further, the software application can provide the user with a virtual map that helps the user locate the different businesses or organizations participating in the software platform. The software can also allow the user to view the interactions that the user has performed historically.

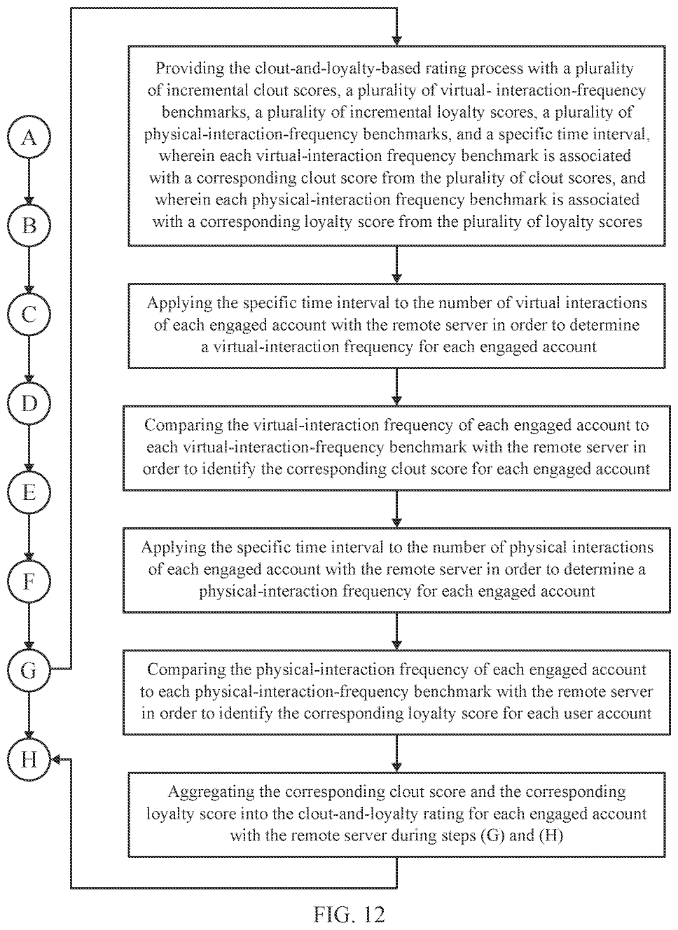

As previously discussed, the method of the present invention enables the rating of the users of the social media network to determine the most influential users that increase the word-of-mouth engagement and the users who are more likely to visit the physical store of the business or organization. To do so, various benchmarks and scores related to the user's virtual interactions and physical interactions are used to calculate each user's cloud-and-loyalty rating. As can be seen in FIGS. 1 and 12, the clout-and-loyalty-based rating process can include a plurality of incremental clout scores, a plurality of virtual-interaction-frequency benchmarks, a plurality of incremental loyalty scores, a plurality of physical-interaction-frequency benchmarks, and a specific time interval. The plurality of incremental clout scores corresponds to the increasing scores that can be assigned to the user's social media posts according to the level of engagement achieved by the social media posts. The plurality of virtual-interaction-frequency benchmarks corresponds to several predetermined virtual benchmarks that can be used to determine the clout scores. For example, the virtual-interaction-frequency benchmarks can include parameters that determine if a user has a low, medium, or high level of frequency in virtual interactions. Each virtual-interaction frequency benchmark is also associated with a corresponding clout score from the plurality of clout scores. Similarly, the plurality of incremental loyalty scores corresponds to the increasing scores that can be assigned to the user according to the level of physical interaction of the user with the physical store of the business or organization. Further, the plurality of physical-interaction-frequency benchmarks corresponds to several predetermined physical benchmarks that can be achieved after certain levels of physical interactions between the user and the physical store of the business or organization. For example, the virtual-interaction-frequency benchmarks can include parameters that determine if a user has a low, medium, or high level of frequency in physical interactions. Each physical-interaction frequency benchmark is also associated with a corresponding loyalty score from the plurality of loyalty scores. Further, the specific time interval corresponds to the time period implemented to collect and process the different scores and benchmarks. For example, the virtual-interaction frequency can be a yearly time interval, a monthly time interval, a weekly time interval, or any other appropriate time interval. The yearly time interval can be synchronized with a fiscal year corresponding to the physical store for accounting purposes. The yearly time interval can help determined clout-and-loyalty ratings for veteran users. The monthly time interval and the weekly time interval can help determine clout-and-loyalty ratings for new users.

As can be seen in FIG. 12, the subprocess of performing the clout-and-loyalty-based rating process utilizing the virtual and physical scores and benchmarks begins by applying the specific time interval to the number of virtual interactions of each engaged account with the remote server in order to determine a virtual-interaction frequency for each engaged account. The virtual-interaction frequency includes a numerical rating of how often the social media user virtually interacts. In other words, the user's virtual interactions are tracked over the specific time interval by the remote server to calculate a total number of virtual interactions performed during the specific time interval, which allows the total number of virtual interactions to be used to calculate the virtual-interaction frequency for the user. The virtual-interaction frequency of each engaged account is then compared to each virtual-interaction-frequency benchmark with the remote server in order to identify the corresponding clout score for each engaged account. This way, an appropriate clout score can be given to the user account according to the virtual-interaction-frequency benchmark achieved by the virtual-interaction frequency of the engaged account. In a similar manner, the specific time interval is applied to the number of physical interactions of each engaged account with the remote server in order to determine a physical-interaction frequency for each engaged account. The physical-interaction frequency includes a numerical rating of how often the social media user physical interacts. Like the virtual interactions, the user's physical interactions are tracked over the specific time interval by the remote server to calculate a total number of physical interactions performed during the specific time interval, which allows the total number of virtual interactions to be used to calculate the virtual-interaction frequency for the user. The physical-interaction frequency of each engaged account is then compared to each physical-interaction-frequency benchmark with the remote server to identify the corresponding loyalty score for each user account. This way, an appropriate loyalty score can be given to the user account according to the physical-interaction-frequency benchmark achieved by the physical-interaction frequency of the engaged account. Finally, the corresponding clout score and the corresponding loyalty score are aggregated into the clout-and-loyalty rating for each engaged account with the remote server during Steps G and H to calculate a final loyalty score over a desired period of time.

The clout-and-loyalty based rating process enables the rating of users based on each user's likelihood to make social media posts about the business or organization and the user's likelihood of visiting the physical store of the business or organization. To do so, the clout-and-loyalty rating can be adjusted to weigh the different parameters mentioned before to accurately rate the user. Further, the clout-and-loyalty rating could be represented by a numerical value within a predetermined scale, such as a score from 1 to 10, or by a color from a color-coded system (e.g., red, yellow, green). In some embodiments, the clout-and-loyalty-based rating process can be implemented for a specific time interval as follows. The corresponding clout score for the specific time interval is calculated by determining the total virtual-interaction frequency and comparing the total virtual-interaction frequency to the virtual-interaction-frequency benchmarks. The total virtual-interaction frequency includes all the virtual interactions the user has performed during the specific time interval. For example, the virtual interactions include the number of virtual advertisements that the user has engaged of the business or organization on the social media network, the number of virtual posts the user has made on the social media network, and the number of virtual posts the user has engaged with on the social media network. Further, each virtual post that the user makes on the social media network can be weighed higher due to the amount of engagement that the virtual post has achieved during the specific time interval. Then, the corresponding clout score for the specific time interval is calculated by determining the total sum of the virtual interactions and determining the virtual-interaction frequency for the specific time interval. For example, the number of virtual advertisements engaged, the number of virtual posts made, and the number of virtual posts engaged can be added up and then divided by the number of time units in the specific time interval (e.g., 30 days in a month) to calculate the average virtual-interaction frequency.

Similarly, the corresponding loyalty score for the specific time interval is calculated by determining the total physical-interaction frequency during the specific time interval. The total physical-interaction frequency includes all physical interactions the user has performed with the physical store of the business or organization. Then, the corresponding loyalty score for the specific time interval is calculated by determining the total sum of the physical interactions and determining the physical-interaction frequency for the specific time interval. For example, the number of physical interactions is totaled and then divided by the number of time units in the specific time interval (e.g., 30 days in a month). Further, the corresponding loyalty score can be increased by the number of in-person financial transactions that the user has performed at the physical store of the business or organization. For example, each purchase the user makes at the physical store of the business or organization can increase the corresponding loyalty score for the specific time interval by the number of purchases the user made during the specific time interval. Then, the corresponding clout score and the corresponding loyalty score are added to calculate the clout-and-loyalty rating for the specific time interval. The clout-and-loyalty rating process can be performed during consecutive time intervals (e.g., monthly, quarterly, yearly, etc.) and the clout-and-loyalty rating can be adjusted according to the different benchmarks set by the business or organization.

Although the invention has been explained in relation to its preferred embodiment, it is to be understood that many other possible modifications and variations can be made without departing from the spirit and scope of the invention.

What is claimed is:

1. A method for assessing a user's likelihood of an in-store visit based on the user's social media activity, the method comprising the steps of:
(A) providing a clout-and-loyalty-based rating process and at least one administrator account managed by at least one remote server, wherein the administrator account is associated with a corresponding administrator personal computing (PC) device;
(B) providing at least one social media network managed by at least one external server, wherein the social media network includes a plurality of user accounts, and wherein the external server is communicably coupled to the remote server, and wherein each user account is associated with a corresponding user PC device;
(C) managing a virtual presence for at least one physical store on the social media network with the external server;
(D) tracking a number of virtual interactions between each user account and the virtual presence with the external server;
(E) designating a plurality of engaged accounts from the plurality of user accounts with the external server, wherein the number of virtual interactions for each engaged account is greater than zero;
(F) tracking a number of physical interactions between each engaged account and the physical store with the remote server;
(G) executing the clout-and-loyalty-based rating process with the remote server by inputting the number of virtual interactions and the number of physical interactions for each engaged account into the clout-and-loyalty-based rating process; and
(H) executing the clout-and-loyalty-based rating process with the remote server by outputting a clout-and-loyalty rating for each engaged account with the clout-and-loyalty-based rating process.

2. The method as claimed in claim 1 comprising the steps of:
prompting the administrator account to post at least one virtual advertisement for the physical store on the social media network with the administrator PC device before step (C); and
posting the virtual advertisement for the physical store on the social media network with the external server during step (C), if the virtual advertisement for the physical store is selected to be posted on the social media network by the administrator account.

3. The method as claimed in claim 1 comprising the steps of:
prompting each user account to engage at least one virtual advertisement as the virtual presence for the physical store with the corresponding user PC device before step (D); and
incrementing the number of virtual interactions for at least one arbitrary user account with the external server during step (D), if the virtual advertisement is selected to be engaged by the arbitrary user account, wherein the arbitrary user account is any account from the plurality of user accounts.

4. The method as claimed in claim 1 comprising the steps of:
prompting each user account to post at least one virtual entry as the virtual presence for the physical store with the corresponding user PC device before step (D); and
incrementing the number of virtual interactions for at least one arbitrary user account with the external server during step (D), if the virtual entry is posted by the arbitrary user account, wherein the arbitrary user account is any account from the plurality of user accounts.

5. The method as claimed in claim 4 comprising the steps of:
providing a plurality of previous negative comments stored by the remote server, wherein the plurality of previous negative comments is contextually related to the physical store;
comparing the virtual entry to each previous negative comment with the remote server in order to identify a contextually-similar comment from the plurality of previous negative comments; and
outputting a negative-comment notification for the virtual entry with the corresponding administrator PC device, if the contextually-similar comment is identified from the plurality of previous negative comments.

6. The method as claimed in claim 5 comprising the step of:
appending a content of the virtual entry as a negative comment into the plurality of previous negative comments with the remote server, if the contextually-matching comment is identified from the plurality of previous negative comments.

7. The method as claimed in claim 1 comprising the steps of:
prompting each user account to engage at least one virtual entry as the virtual presence for the physical store with the corresponding user PC device before step (D); and
incrementing the number of virtual interactions for at least one arbitrary user account with the external server during step (D), if the virtual entry is engaged by the arbitrary user account, wherein the arbitrary user account is any account from the plurality of user accounts.

8. The method as claimed in claim 1 comprising the steps of:
providing the physical store with a geofenced area managed by the remote server;
tracking a geolocation of each engaged account through the corresponding user PC device with the external server after step (E);
relaying the geolocation of each engaged account from the external server to the remote server; and
incrementing the number of physical interactions for at least one arbitrary engaged account with the remote server during step (F), if the geolocation of the arbitrary engaged account is within the geofenced area, wherein the arbitrary engaged account is any account from the plurality of engaged accounts.

9. The method as claimed in claim 1 comprising the steps of:
providing a plurality of sales records for the physical store managed by the remote server, wherein each sales record includes purchaser information and purchase information;
providing each user account with a user profile managed by the external server;
relaying the user profile for each engaged account from the external server to the remote server;
comparing the purchaser information of each sales record to the user profile of each engaged account with the remote server in order to identify at least one matching account from the plurality of engaged accounts, wherein the purchaser information of at least one specific record from the plurality of sales records contextually matches the user profile of the matching account; and
incrementing the number of physical interactions for the matching account with the remote server during step (F), if the matching account is identified from the plurality of engaged accounts.

10. The method as claimed in claim 1 further comprising the steps of:
providing the clout-and-loyalty-based rating process with a plurality of incremental clout scores, a plurality of virtual-interaction-frequency benchmarks, a plurality of incremental loyalty scores, a plurality of physical-interaction-frequency benchmarks, and a specific time interval, wherein each virtual-interaction frequency benchmark is associated with a corresponding clout score from the plurality of clout scores, and wherein each physical-interaction frequency benchmark is associated with a corresponding loyalty score from the plurality of loyalty scores;
applying the specific time interval to the number of virtual interactions of each engaged account with the remote server in order to determine a virtual-interaction frequency for each engaged account;
comparing the virtual-interaction frequency of each engaged account to each virtual-interaction-frequency benchmark with the remote server in order to identify the corresponding clout score for each engaged account;
applying the specific time interval to the number of physical interactions of each engaged account with the remote server in order to determine a physical-interaction frequency for each engaged account;
comparing the physical-interaction frequency of each engaged account to each physical-interaction-frequency benchmark with the remote server in order to identify the corresponding loyalty score for each user account; and
aggregating the corresponding clout score and the corresponding loyalty score into the clout-and-loyalty rating for each engaged account with the remote server during steps (G) and (H).

11. The method as claimed in claim 10, wherein the specific time interval is a yearly time interval.

12. The method as claimed in claim 10, wherein the specific time interval is a monthly time interval.

13. The method as claimed in claim 10, wherein the specific time interval is a weekly time interval.
